(19) United States
(12) Patent Application Publication
(10) Pub. No.: US 2017/0305065 A1
(43) Pub. Date: Oct. 26, 2017

(54) Manufacturing process

(71) Applicant: Cheng Kuan Wu, Lianyungang City (CN)

(72) Inventor: Cheng Kuan Wu, Lianyungang City (CN)

(21) Appl. No.: 15/643,498

(22) Filed: Jul. 7, 2017

(51) Int. Cl. B29C 64/106; B33Y 10/00; B29C 64/188; B29C 64/295

(52) U.S. Cl. CPC B29C 64/106; B29C 64/295; B33Y 10/00; B29C 64/188

(57) ABSTRACT

A manufacturing process includes creating 3D shells having a sprue; connecting the 3D shells together to arrange as rows of the 3D shells which are placed in a box filled with sand; placing the box in a vacuum chamber; activating a vacuum pump to compact the sand; activating an induction heater to preheat the box; shaking the box; introducing a molten material from an induction furnace into the sprue of each 3D shell until each 3D shell is filled with the molten material; pumping inert gas into the vacuum chamber to increase pressure in the vacuum chamber until an internal pressure of the vacuum chamber is greater than the atmospheric pressure; gradually cooling the box; taking the box out of the vacuum chamber; separating the 3D shells from the sand; cutting to obtain the 3D shells; rubbing each 3D shell; and removing the sand to finish 3D objects.

### BACKGROUND OF THE INVENTION

### 1. Field of the Invention

The invention relates to manufacturing processes and more particularly to a manufacturing process involving 3D (three-dimensional) printing and other improved characteristics.

### 2. Description of Related Art

A conventional manufacturing process comprising processing circuitry at a server retrieving a source model comprising a shell portion and an internal components portion for a 3D object and defined control points relating to aspects of the shell portion for the 3D object, wherein the shell portion comprises a low resolution exterior surface mesh including a series of interconnected polygons with the control points relating to vertices of the exterior surface mesh and the internal components portion comprises a high resolution mesh; transmitting the low resolution exterior surface mesh of the shell portion and the control points relating to aspects of the shell portion from the server to a user device; displaying a representation model of the received low resolution exterior surface mesh; receiving user specified modifications to the control points; transmitting the modifications the server; processing circuitry at the server receiving the modifications from the user device; processing circuitry at the server applying the received modifications to the source model to create a modified model; processing circuitry at the server subdividing a surface of the modified model to create a high resolution model; processing circuitry at the server modifying the high resolution model wherein modifying the high resolution model by combining with the internal components portion of the source model includes modifying positioning of the internal components portion based on the received modifications to the control points and internal components portion constraint data; and processing circuitry at the server generating print instructions based on the modified high resolution model for manufacture of the 3D object.

While the manufacturing process enjoys its success in the market, continuing improvements in the manufacturing process are constantly being sought.

### SUMMARY OF THE INVENTION

It is therefore one object of the invention to provide a manufacturing process comprising the steps of (a) repeatedly performing the sub-steps of (a1) drawing a design based on specifications of an object, (a2) converting the drawing into a computer file, and (a3) inputting the computer file to a 3D printer to create a 3D shell having a sprue wherein the 3D shell has a thickness of between 0.5 mm and 10 mm until a predetermined number of the 3D shells are created; (b) connecting a plurality of the 3D shells together to arrange as a plurality of rows of the 3D shells; (c) placing the rows of the 3D shells in a box; (d) filling the box with sand to fasten the rows of the 3D shells; (e) placing the box in a vacuum chamber; (f) activating a vacuum pump to compact the sand in the box; (g) activating an induction heater to preheat the box to a predetermined temperature; (h) activating a vibration device to shake the rows of the 3D shells in the box; (i) introducing a molten material from an induction furnace into the sprue of each 3D shell until each 3D shell is filled with the molten material; (j) pumping inert gas into the vacuum chamber to increase pressure in the vacuum chamber until an internal pressure of the vacuum chamber is greater than the atmospheric pressure; (k) gradually cooling the box; (l) taking the box out of the vacuum chamber; (m) shaking the box to separate the rows of the 3D shells from the sand; (n) cutting the rows of the 3D shell to obtain a plurality of the 3D shells; (o) rubbing each 3D shell; and (p) removing the sand to finish a plurality of 3D objects.

The above and other objects, features and advantages of the invention will become apparent from the following detailed description taken with the accompanying drawings.

### BRIEF DESCRIPTION OF THE DRAWINGS

FIG. 1 is a flow chart of a manufacturing process according to the invention; and

FIG. 2 is a continuation of FIG. 1.

### DETAILED DESCRIPTION OF THE INVENTION

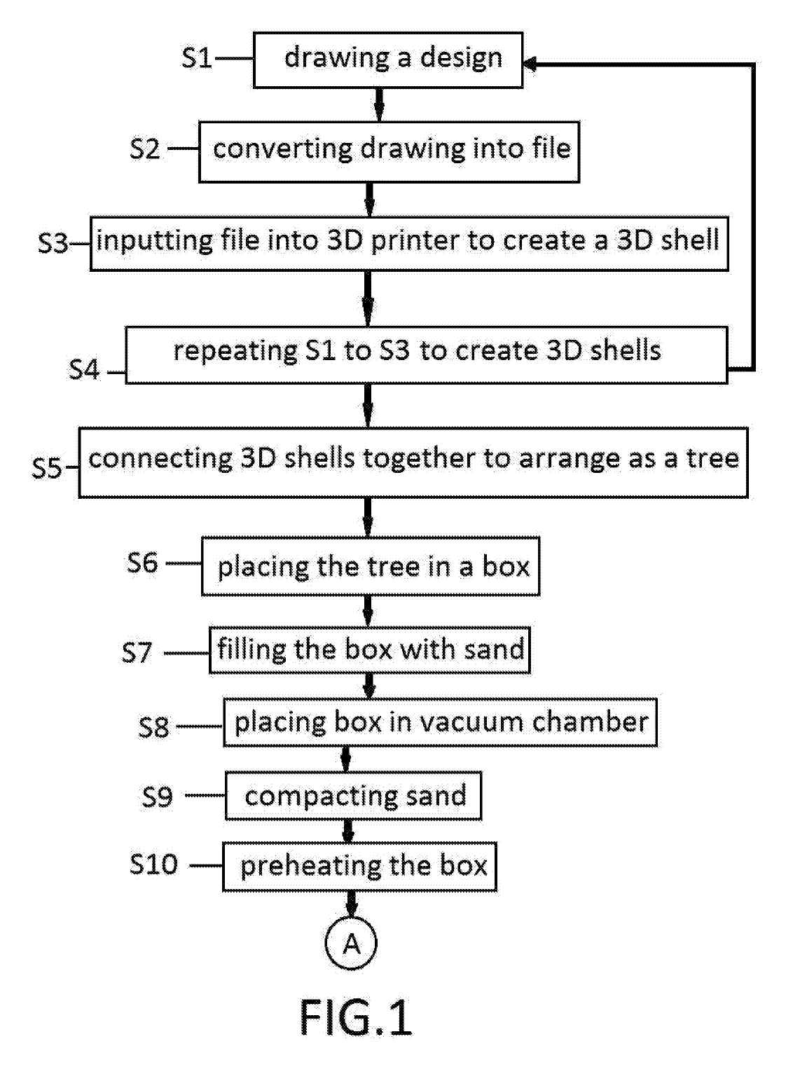

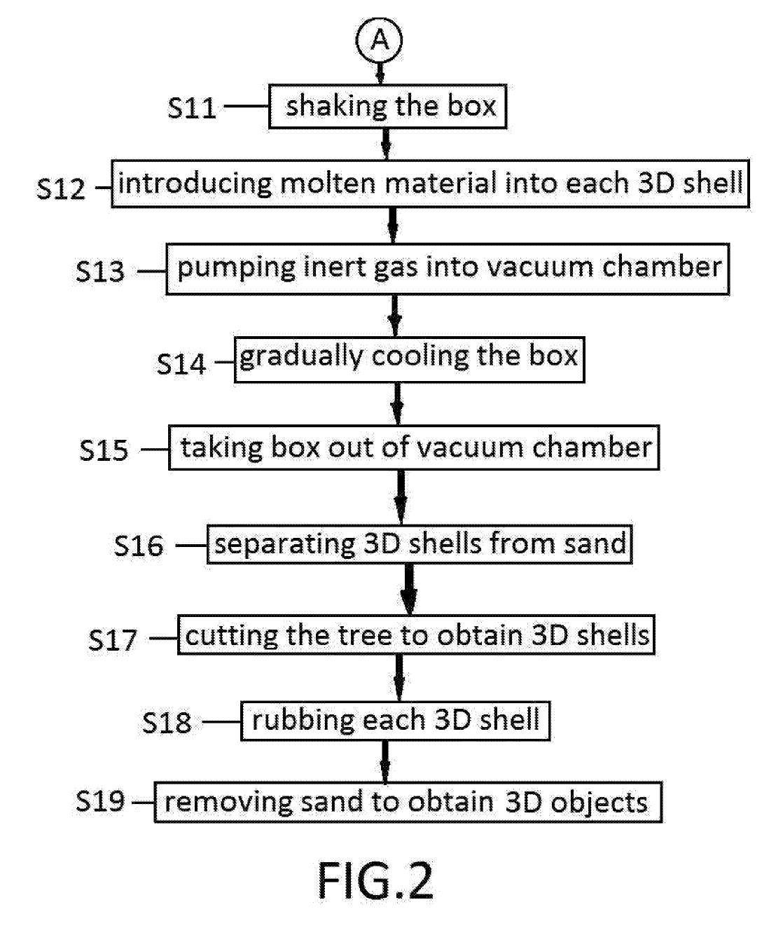

Referring to FIGS. 1 and 2, a flow chart of manufacturing process in accordance with the invention is illustrated. The process comprising the steps of:

Step S1: drawing a design based on specifications of a product.

Step S2: converting the drawing into a computer file.

Step S3: inputting the computer file into a 3D printer to create a 3D shell having a sprue wherein the 3D shell is thin and has a thickness of between 0.5 mm and 10 mm. It makes gas easily penetrate through the 3D shell and facilitates molten material introduction. Further, it necessitates the filling of sand in the box for compaction purposes to be discussed later. The thin 3D shells can save material, decrease the amount of waste, and decrease the manufacturing cost. These are first characteristics of the invention.

Step S4: repeating steps S1 to S3 until a predetermined number of the 3D shells are created.

Step S5: connecting a plurality of the 3D shells together to arrange as a plurality of rows of the 3D shells (i.e., a tree structure) wherein the 3D shells can be of different shapes and/or sizes (i.e., different parts or products to be produced). This makes a single manufacturing process be capable of manufacturing a plurality of different products. This is a second characteristic of the invention.

Step S6: placing the rows of the 3D shells in a box.

Step S7: filling the box with at least one kind of sand to fasten the rows of the 3D shells. This can increase a resistance of the rows of the 3D shells in a subsequent molten material introduction step and is a third characteristic of the invention.

Step S8: placing the box in a vacuum chamber.

Step S9: activating a vacuum pump to compact the sand in the box.

Step S10: activating an induction heater to preheat the box to a predetermined temperature. The heated rows of the 3D shells can decrease its temperature difference with the molten material to be introduced into each 3D shell so that the rows of the 3D shells are prevented from being broken. These are fourth characteristics of the invention.

Step S11: activating a vibration device to shake the rows of the 3D shells in the box for compacting the sand in the box. This is a fifth characteristic of the invention.

Step S12: introducing a molten material from an induction furnace into the sprue of each 3D shell until each 3D shell is filled with the molten material.

Step S13: pumping inert gas into the vacuum chamber to increase pressure in the vacuum chamber until internal pressure of the vacuum chamber is greater than the atmospheric pressure.

Step S14: gradually cooling the box. Steps S13 and S14 can increase uniformity and density of the parts of products to be produced later. Steps S13 and S14 are sixth characteristics of the invention.

Step S15: taking the box out of the vacuum chamber.

Step S16: shaking the box to separate the rows of the 3D shells from the sand.

Step S17: cutting the rows of the 3D shell to obtain a plurality of the 3D shells.

Step S18: rubbing each 3D shell.

Step S19: removing the sand to finish 3D parts or products.

While the invention has been described in terms of preferred embodiments, those skilled in the art will recognize that the invention can be practiced with modifications within the spirit and scope of the appended claims.

What is claimed is:

1. A manufacturing process comprising the steps of:
(a) repeatedly performing the sub-steps of (a1) drawing a design based on specifications of an object, (a2) converting the drawing into a computer file, and (a3) inputting the computer file to a 3D printer to create a 3D shell having a sprue wherein the 3D shell has a thickness of between 0.5 mm and 10 mm until a predetermined number of the 3D shells are created;
(b) connecting a plurality of the 3D shells together to arrange as a plurality of rows of the 3D shells;
(c) placing the rows of the 3D shells in a box;
(d) filling the box with sand to fasten the rows of the 3D shells;
(e) placing the box in a vacuum chamber;
(f) activating a vacuum pump to compact the sand in the box;
(g) activating an induction heater to preheat the box to a predetermined temperature;
(h) activating a vibration device to shake the rows of the 3D shells in the box;
(i) introducing a molten material from an induction furnace into the sprue of each 3D shell until each 3D shell is filled with the molten material;
(j) pumping inert gas into the vacuum chamber to increase pressure in the vacuum chamber until an internal pressure of the vacuum chamber is greater than the atmospheric pressure;
(k) gradually cooling the box;
(l) taking the box out of the vacuum chamber;
(m) shaking the box to separate the rows of the 3D shells from the sand;
(n) cutting the rows of the 3D shell to obtain a plurality of the 3D shells;
(o) rubbing each 3D shell; and
(p) removing the sand to finish a plurality of 3D objects.
